(19) United States
(12) Patent Application Publication
(10) Pub. No.: US 2019/0126523 A1
(43) Pub. Date: May 2, 2019

(54) MULTIFUNCTIONAL VISCOELASTIC COMPRESSIVE APPLICATOR

(71) Applicant: John T. Kucala, III, Grand Junction, MI (US)

(72) Inventor: John T. Kucala, III, Grand Junction, MI (US)

(21) Appl. No.: 16/175,757

(22) Filed: Oct. 30, 2018

Related U.S. Application Data
(60) Provisional application No. 62/579,101, filed on Oct. 30, 2017.

(51) Int. Cl. B29C 44/12; B29C 44/58

(52) U.S. Cl. CPC B29C 44/1228; B29K 2075/00; B29C 44/58

(57) ABSTRACT

According to some embodiments, a system and a method of creating a multifunctional viscoelastic compressive applicator comprising: obtaining a mold, the mold having a plurality of appendages protruding from the interior surfaces of the mold towards the interior of the mold cavity and the plurality of appendages capable of creating a plurality of slices, indentations, cavities, hollows, voids or augmentations in a finished product; filling the mold with a predetermined amount of viscoelastic material; closing the mold cover to create a fixed mold cavity volume inside the mold; and allowing the predetermined amount of viscoelastic material to expand and cure inside the fixed volume of the mold whereby the expanding and curing of the predetermined amount of viscoelastic material inside the mold fills the mold and creates a compressive force that acts on the viscoelastic material to create the finished product is presented.

### CROSS-REFERENCE TO RELATED APPLICATIONS

This application claims priority to U.S. Provisional Application No. 62/579,101 filed Oct. 30, 2017, and incorporated herein by reference in its entirety.

### FIELD

A method for creating a multifunctional viscoelastic compressive applicator is generally described.

More specifically, a multifunctional viscoelastic compressive applicator system comprising a combination of both chemical and mechanical variations and augmentations such that a user has increased ergonomic comfort, increased operational advantages and an enhanced provisionally fastened grip during a targeted operation of washing, cleaning, scrubbing, abrading, polishing, waxing or coating on a variety of work surfaces.

### BACKGROUND

The present invention relates to washing, cleaning, scrubbing, abrading, polishing, waxing or coating of various work surfaces in a variety of different fields of operations including but not limited to interior and exterior of surfaces in the automotive, marine, rail and aviation industry. More specifically, the present invention comprises a combination of resins to form a viscoelastic compressive applicator having a combination and plurality of purposeful linear and nonlinear slices, indentations, cavities, hollows, voids or augmentations on one or more planar surfaces of the applicator which provide the user with the ability to have a provisionally removable fastened grip, enhanced control and performance to combat frictional forces, and a parity of selected compressive force during the targeted application. Another embodiment of the presently claimed invention is to provide a means of an operational advantage for an operator to switch universally from a machine operation to a hand operation without the need for additional tools, thus reducing both material and labor costs in a targeted operation.

In the washing, scrubbing, abrading, cleaning, polishing, waxing or coating of various work surfaces there is a mass variety of different applicators for an operator to choose from. Many of the related art products comprise applicators that are open and/or closed cell, sponge or foam blocks or carvings thereof; while others are precise ornamental shapes which are produced by what is known in the art as injection molding and some having purely ornamental design and others having specific purposeful designs as will be discussed herein.

In the related art, there are many different tools, some operated by hand while others operated with the use of a machine polisher and thus requiring different tools for each targeted operation and objective. It is an object of the present invention to create a multifunctional viscoelastic applicator that can be conveniently used in an operation both by the operators hand, and also while having the ability of being affixed to a machine polisher and being universally and seamlessly interchangeable from one operation to the other without the use of additional tools, materials or means.

As it is taught in the art, many applicators comprise a type of “hook” material that is affixed to a planar side of the applicator for the use of adapting provisional accessories during the targeted operations.

The most closely related art in the field of this present invention are U.S. Pat. No. 8,430,724 by Tsai, “Surface Cleaning System and Method”, USD 716,631 by Miller “Contoured Vehicle Surface Polisher and Restorer”, US20150105003A1 by Miller “Media Bearing Polisher and Restorer” U.S. Pat. No. 7,094,449 by Boler, “Device and System for Coating a Surface and Reducing Irregularities,” U.S. Pat. No. 6,379,237 by Gordon, “Abrasive Sponge Grip”, U.S. Pat. No. 6,616,519 Mansfield, “Sanding System” U.S. Pat. No. 6,547,643 by Miller “Surface Polishing Applicator System and Method”, U.S. Pat. No. 5,131,193 by Demers, “Contoured Sanding Device”, and U.S. Patent NO. USRE37486E1 by Stanzione “Contouring sanding system comprising elongated sides, flanges, thumb fossas and finger fillisters.”

As it is taught in the art, the applicators can be formed of open or closed cell foam, sponges or the like having disclosed features such as compressible, resilient, flexible and rigid materials having a variety of embodiments including flanges, fossa's, fillisters, flutes, elongated handles and the like.

While there are many different ornamental features of the related art, some disclose precise features over others to achieve their targeted operational objective.

However, with a view of the related art, none comprise the combination of viscoelastic compressive materials with linear and non-linear slices, cavities, hollows, voids or augmentations to provide the operator with the ability to achieve an enhanced provisionally removable fastened grip which delivers enhanced operational advantages during the targeted objective.

In view of the disadvantages associated with currently available methods and devices for multifunctional viscoelastic compressive applicator system comprising a combination of both chemical and mechanical variations and augmentations, there is a need for an improved device and method of creating a multifunctional viscoelastic compressive applicator.

### BRIEF DESCRIPTION

Specifically, the multifunctional viscoelastic compressive applicator of present invention comprises the use of flexible polyurethane foams within a range of 3 lbs/ft3 up to 25 lbs/ft3 to produce a viscoelastic compressible applicator comprising linear and non-linear slices, indentations, cavities, hollows, voids and augmentations.

The linear and non-linear slices, cavities, indentations and augmentations provide an ergonomically enhanced grip for the operator while combined with the cavities, hollows or voids provide the user with an even further enhanced operational benefit of providing the operator with having the ability to utilize a provisionally removable fastened grip and more control over frictional forces during the targeted operation.

The operational benefits of the present invention further can be outlined in the specific viscoelastic compressibility for each targeted operational objective. For example, in one embodiment in accordance of the presently claimed invention whereas the applicator of the present invention is comprised of a viscoelastic material having a density of 3 lbs/ft3, this provides a very soft and compressible applicator having a compressive density which is similar to that of a “marshmallow” and at the higher end of the spectrum utilizing a density of 25 lbs/ft3 provides a compressive density more firm and closer to the consistency of a “racquet ball.”

Formulating applicators according to the present invention utilizing the higher end of the spectrum such as 25 lbs/ft3 would be more target specific and suitable for scrubbing, abrading, cleaning, polishing and coating objectives while formulating applicators according to the present invention utilizing viscoelastic materials closer to the density of 3 lbs/ft3 would be more target specific and suitable for applications such as washing, cleaning, polishing, waxing or coating objectives.

Often, the targeted work surface comprises a varied texture with dimensional voids. These type of varied textured surfaces can be difficult to wash, clean, scrub, polish or coat, especially with tools that are produced in the range of 25 lbs/ft3 or higher. Therefore, it is an object of the present invention to provide a multifunctional viscoelastic compressive applicator comprising linear and non-linear slices, indentations, cavities, hollows, voids or augmentations that is softer and more compressible to mate with the textured work surface and dimensional voids for an enhanced targeted operation.

Applicators of the related art such as the one disclosed in U.S. Pat. No. 8,430,724 by Tsai, “Surface Cleaning System and Method”, and as in the US20150105003A1 “Media Bearing Polisher and Restorer” have both similarities in the operational disclosures, design and compressive density which are estimated to be higher than 25 lbs/ft3. Applicators produced per these disclosures which are available in commerce have compressive densities which is very firm, and more closely related to the firmness and rigidity of a highly inflated “basketball.”

Utilizing a method of the presently claimed invention whereas the viscoelastic materials are dispensed into a constrictive cavity also has operational advantages over the existing art.

The lighter densities of sponge or foams of the related art, comprise a method whereas during the foaming operation, the foam is allowed to fully expand into an open cavity which produces what's commonly referred to in the art as a “bale.” The bale is then carved and sliced to produce sheets, blocks or precise tools of desired shapes.

As it is taught in the art, some of these sheets, carvings or precise tools utilize a hook or loop material which requires a separate gluing and/or laminating procedure using additional materials and procedures in order to affix the hook or loop material to the sheets, blocks or precise tools. Because of the open cell structure of many of these foams, the hook or loop material cannot bond securely to the foam material utilizing standard gluing methods. In other situations of the prior art, a separate plastic film is placed between the hook or loop material and the foam material, and then the sandwiched article is put through a heated laminator to bond the hook or loop material to the foam. In yet other situations, there is a flame lamination procedure that is utilized in which the foam slab is passed under an open flame to melt a planar side of the foam slab so that hook or loop material can be mated to the melted portion of the foam slab to form a bond. This provides many operational limitations to these types of carvings or precise tools in respect to mating of the hook or loop material.

In the related art such as that of the 724 patent by Tsai, and the 643 patent by Miller, the practice is to utilize the more firm and rigid materials (such as the firmness and rigidity of a fully inflated basketball), especially whereas the incorporation of the hook material is desired for the targeted polishing operation.

In the prior art situations whereas the higher density materials and injection molding techniques are used, the hook material is often placed into the tool cavity prior to injection molding because this provides proper adhesion between the hook material and the tool material itself.

According to the presently claimed invention, the selected polyurethane foams within a density range of 3lbs/ft3 and 25 lbs/ft3 and a method of utilizing constrictive mold techniques of the present invention provides a means for both achieving target specific viscoelastic compressive properties incorporating the combination and plurality of purposeful linear and nonlinear slices, indentations, cavities, hollows, voids or augmentations on one or more planar surfaces of the applicator, combined with an enhanced feature of allocating proper bonding of the hook material such as to increase or expand the operational boundaries of the finished applicator.

Accordingly with the presently claimed materials and methods, incorporating the hook material into the mold cavity while using constrictive means, provides an enhanced chemical bond between the viscoelastic materials and the hook material.

Foam of the related art for use as washing sponges, utilize larger open cell foam structures, thereby soaking up large amounts of fluids, and are not desirable for waxing, polishing or coating applications. Heavier and more compressive densities of the related art applicators are closed cell structures which do not soak up liquids, and are thereby not desirable for washing, cleaning, polishing or coating applications.

It is an object of the presently claimed invention to provide a means of utilizing a viscoelastic compressible cell structure and a constrictive mold technique to generate a tighter hybrid cell structure that can be utilized over a broader range of target specific applications.

Accordingly, in the present invention when using a foaming material which is allowed to fully expand without any compressive restrictions, it creates an abundance of larger open cells throughout the viscoelastic article which range from 0.25 cm up to 0.5 cm. When using the same amount of foaming material in a constrictive cavity according to the present invention, it is observed that it is virtually free of any larger open cells within the range of 0.25 cm to 0.5 cm throughout the majority of the viscoelastic article.

It is observed that the method of producing an article using the compressive restriction of the present invention alters both the volume and density of the foam article itself.

For example 80 (eighty) grams of viscoelastic foam was placed into a cavity and allow to expand unrestricted. This produced a viscoelastic foam article that was approximately 5.5″×1.25″ and thereby equal to 0.572 cubic feet and approximately 3.213 lbs. per cubic foot. This was determined by taking the diameter of the article which was 5.5″ and multiplying it by the depth of the article which was 1.25″. The mass of the article was 6.875″ which was then divided by 12″ to provide an estimated 0.572 cubic foot of volume. Since the viscoelastic article weighed 80 grams which was divided by 448 (total grams per pound), it was calculated that the article was equal to 0.178 lbs. Thereby the volume of 0.572 is divided by the weight of 0.178 to equal 3.213 pounds per cubic foot.

Additionally, 80 (eighty) grams of viscoelastic foam was placed in a cavity with compressive restrictions. This produced an article that was 5.5″×1″ and thereby equal to 0.458 cubic foot and approximately 2.57 lbs. per cubic foot.

Moreover, it is an object of the present invention to provide a means for the operator to have a provisionally removable fastened grip during a targeted operation. In most of the target operations the operation incorporates some type of liquid which can be water or a lubricant having a high lubricity or slip value; which can make it difficult for the operator to maintain a suitable grip of a tool during the targeted operation.

During a targeted operation of washing, cleaning, abrading, scrubbing, polishing or coating, there are many different frictional forces at play to which a user must deal with. It is an object of the present invention to reduce operator fatigue, reduce waste and increase performance by incorporating a combination of viscoelastic compressive resins with one or more slices, indentations, cavities, hollows voids or augmentations to produce a multifunctional viscoelastic compressive applicator.

The slices, indentations, cavities, hollows or voids of the present invention can be various geometric or non geometric shapes and can comprise cylindrical, oblong, uniform or graduated and/or a combination thereof placed on one or more planar surfaces of the multifunctional viscoelastic applicator. It is an operational benefit of the present invention for the slices, indentations, cavities, hollows, voids or augmentations to be graduated so that they can accommodate a wide variety of different operators and further such that the operators fingers can fit securely into the slices, indentations, cavities, hollows or voids to provide the operator with a means of having a provisionally removable fastened grip.

Accordingly, in the present invention there is a combination of operational advantages of both having the viscoelastic resin in the range of 3 lbs/ft3 to 25 lbs/ft3 and having cylindrical, oblong, uniform or graduated slices, indentations, cavities, hollows or voids in the multifunctional viscoelastic applicator.

Accordingly, the applicator of the presently claimed invention is both viscoelastic and compressive and thereby provides an operator with a comfortable and ergonomic means of having a provisionally removable means of securing the applicator during the operation.

Prior to undertaking a targeted operation using an applicator of the present invention, an operator would grip the applicator and place the operators fingers together with the slices, indentations, cavities, hollows or voids whether graduated or non graduated.

In another embodiment of the present invention, it is possible to utilize a resin within a higher density range of 25 lbs/ft3 while also utilizing a combination of graduated linear and non-linear slices, indentations, cavities, hollows or voids. While the higher range of the elasticity modulus in this embodiment of the applicator may not be as viscoelastic or compressive as the lower range, utilizing the combination of graduated, linear, non-linear slices, indentations, cavities, hollows or voids provides an operator with an enhanced grip during a targeted operation.

It is an object of the present invention for sizing of the linear and non-linear slices, indentations, cavities, hollows or voids to be within a selected range of 0 to 10 cm in diameter either cylindrical or non cylindrical and either uniform or transverse in proportion to the planar working surface of the applicator.

Further, it is an object of the present invention for the depth of the linear and non-linear slices, indentations, cavities, hollows, or voids to be within a selected range that is equal to or slightly less than the overall selected depth of the applicator itself.

In one embodiment of the present invention, there is no “hook” material applied to a planar surface of the applicator.

In another embodiment of the present invention, there is a “hook” material applied to at least one planar side of the applicator.

In another embodiment of the present invention, there is a “hook” material applied to more than one planar side of the applicator.

In another embodiment of the present invention, there is a “loop” material applied to at least one planar side of the applicator.

In another embodiment of the present invention, there is a “loop” material applied to at least one planar side of the applicator in combination with a “hook” material that is applied to at least one planar side of the applicator.

There is an added operational benefit of the present invention by incorporating a “loop” material on at least one planar side of the applicator. By incorporating “loop” material to at least one planar surface of the applicator, this provides an operator with a means of universally interchanging seamlessly between hand and machine operations thereby lowering overall costs and increasing productivity.

There is another added operational benefit of having both a hook material applied to at least one planar side of the applicator, and a loop material applied to at least one planar size of the applicator. In this embodiment, the user can have a dedicated viscoelastic applicator having slices, indentations, cavities, hollows or voids that is formed of a precise viscoelastic density that can mated with other viscoelastic applicators having varied compressive density between 3 lbs/ft3 to 25 lbs/ft3.

In another embodiment of the present invention, there is an added element of making the applicator with augmentations protruding from at least one planar side of the applicator. In this embodiment, the augmentation protruding from at least one planar side of the applicator provides an operator with yet another means of an enhanced grip to control the frictional force that is created during the targeted operation.

In another embodiment of the present invention, there is at least one augmentation on at least one planar side of the applicator.

In another embodiment of the present invention, there is at least one or more augmentations on at least one side of a planar side of the applicator.

In another embodiment of the present invention, there is at least one augmentation of at least one planar side of the applicator, in combination with at least one linear or non-linear slice, indentation, cavity, hollow or void.

In another embodiment of the present invention, there is at least one or more augmentations on at least one planar side of the applicator, in combination with at least one linear or non-linear slice, indentation, cavity, hollow or void.

In another embodiment of the present invention, the augmentations on the applicator are even with a planar side of the applicator.

In another embodiment of the present invention, the augmentations on the applicator are slightly less than at least one planar side of the applicator.

In one embodiment of a method of creating a multifunctional viscoelastic compressive applicator comprising: obtaining a mold, the mold having a plurality of appendages protruding from the interior surfaces of the mold towards the interior of the mold cavity and the plurality of appendages capable of creating a plurality of slices, indentations, cavities, hollows, voids or augmentations in a finished product; filling the mold with a predetermined amount of viscoelastic material; closing the mold cover to create a fixed mold cavity volume inside the mold; and allowing the predetermined amount of viscoelastic material to expand and cure inside the fixed mold cavity volume of the mold whereby the expanding and curing of the predetermined amount of viscoelastic material inside the mold fills the mold and creates a compressive force that acts on the viscoelastic material to create the finished product.

In another embodiment of the method of creating the multifunctional viscoelastic compressive applicator further comprises wherein the finished product has a density in the range of between two (2) pounds per cubic foot and twenty-five (25) pounds per cubic foot.

In yet another embodiment of the method of creating the multifunctional viscoelastic compressive applicator further comprises wherein the finished product has a density in the range of between two (2) pounds per cubic foot and four (4) pounds per cubic foot.

In still another embodiment of the method of creating the multifunctional viscoelastic compressive applicator further comprises wherein the plurality of appendages creating the plurality of slices, indentations, cavities, hollows, voids or augmentations are configured so that the plurality of slices, indentations, cavities, hollows, voids or augmentations are wider at an outer surface of the finished product and taper down narrower as the slices, indentations, cavities, hollows, voids or augmentations go deeper into the finished product.

In another embodiment of the method of creating the multifunctional viscoelastic compressive applicator further comprises wherein the plurality of appendages creating the plurality of slices, indentations, cavities, hollows, voids or augmentations are configured so that the plurality of slices, indentations, cavities, hollows, voids or augmentations are at an angle other than perpendicular to an outer surface of the finished product.

In one embodiment of a method of creating a multifunctional viscoelastic compressive applicator comprising: obtaining a mold, the mold having a plurality of appendages protruding from the interior surfaces of the mold towards the interior of the mold cavity and the plurality of appendages capable of creating a plurality of slices, indentations, cavities, hollows, voids or augmentations in a finished product; placing a first attachment mechanism onto a first at least one interior surface of the mold; filling the mold with a predetermined amount of viscoelastic material; closing the mold cover to create a fixed mold cavity volume inside the mold; and allowing the predetermined amount of viscoelastic material to expand and cure inside the fixed mold cavity volume of the mold whereby the expanding and curing of the predetermined amount of viscoelastic material inside the mold fills the mold and creates a compressive force that acts on the viscoelastic material to affix the first attachment mechanism to the predetermined amount of viscoelastic material to create the finished product.

In another embodiment of the method of creating the multifunctional viscoelastic compressive applicator further comprises wherein the finished product has a density in the range of between two (2) pounds per cubic foot and twenty-five (25) pounds per cubic foot.

In yet another embodiment of the method of creating the multifunctional viscoelastic compressive applicator further comprises wherein the finished product has a density in the range of between two (2) pounds per cubic foot and four (4) pounds per cubic foot.

In still another embodiment of the method of creating the multifunctional viscoelastic compressive applicator further comprises wherein the plurality of appendages creating the plurality of slices, indentations, cavities, hollows, voids or augmentations are configured so that the plurality of slices, indentations, cavities, hollows, voids or augmentations are wider at an outer surface of the finished product and taper down narrower as the slices, indentations, cavities, hollows, voids or augmentations go deeper into the finished product.

In another embodiment of the method of creating the multifunctional viscoelastic compressive applicator further comprises wherein the plurality of appendages creating the plurality of slices, indentations, cavities, hollows, voids or augmentations are configured so that the plurality of slices, indentations, cavities, hollows, voids or augmentations are at an angle other than perpendicular to an outer surface of the finished product.

In yet still another embodiment of the method of creating the multifunctional viscoelastic compressive applicator further comprises wherein the first attachment mechanism placed onto the first at least one interior surface of the mold is at least one of a hook and loop fastener, a male and female fastener, or a surface tension fastener.

In one embodiment of a method of creating a multifunctional viscoelastic compressive applicator comprising: obtaining a mold, the mold having a plurality of appendages protruding from the interior surfaces of the mold towards the interior of the mold cavity and the plurality of appendages capable of creating a plurality of slices, indentations, cavities, hollows, voids or augmentations in a finished product; placing a first attachment mechanism onto a first at least one interior surface of the mold; placing a second attachment mechanism onto a second at least one interior surface of the mold; filling the mold with a predetermined amount of viscoelastic material; closing the mold cover to create a fixed mold cavity volume inside the mold; and allowing the predetermined amount of viscoelastic material to expand and cure inside the fixed mold cavity volume of the mold whereby the expanding and curing of the predetermined amount of viscoelastic material inside the mold fills the mold and creates a compressive force that acts on the viscoelastic material to affix the first attachment mechanism and the second attachment mechanism to the predetermined amount of viscoelastic material to create the finished product.

In another embodiment of the method of creating the multifunctional viscoelastic compressive applicator further comprises wherein the finished product has a density in the range of between two (2) pounds per cubic foot and twenty-five (25) pounds per cubic foot.

In yet another embodiment of the method of creating the multifunctional viscoelastic compressive applicator further comprises wherein the finished product has a density in the range of between two (2) pounds per cubic foot and four (4) pounds per cubic foot.

In still another embodiment of the method of creating the multifunctional viscoelastic compressive applicator further comprises wherein the plurality of appendages creating the plurality of slices, indentations, cavities, hollows, voids or augmentations are configured so that the plurality of slices, indentations, cavities, hollows, voids or augmentations are wider at an outer surface of the finished product and taper down narrower as the slices, indentations, cavities, hollows, voids or augmentations go deeper into the finished product.

In still yet another embodiment of the method of creating the multifunctional viscoelastic compressive applicator further comprises wherein the plurality of appendages creating the plurality of slices, indentations, cavities, hollows, voids or augmentations are configured so that the plurality of slices, indentations, cavities, hollows, voids or augmentations are at an angle other than perpendicular to an outer surface of the finished product.

In another embodiment of the method of creating the multifunctional viscoelastic compressive applicator further comprises wherein the first attachment mechanism placed onto the first at least one interior surface of the mold is at least one of a hook and loop fastener, a male and female fastener, or a surface tension fastener.

In yet still another embodiment of the method of creating the multifunctional viscoelastic compressive applicator further comprises wherein the second attachment mechanism placed onto the second at least one interior surface of the mold is at least one of a hook and loop fastener, a male and female fastener, or a surface tension fastener.

These and other features, aspects, and advantages of the various embodiments of the present invention will become better understood with reference to the following drawings, descriptions, and claims.

### BRIEF DESCRIPTION OF THE FIGURES

A more particular description will be rendered by reference to specific embodiments thereof that are illustrated in the appended drawings. Understanding that these drawings depict only typical embodiments thereof and are not therefore to be considered to be limiting of its scope, exemplary embodiments will be described and explained with additional specificity and detail through the use of the accompanying drawings in which:

FIG. 1 is a top view of a mold for a method of creating a multifunctional viscoelastic compressive applicator according to an embodiment;

FIG. 2 is a cross-sectional side view of a mold for a method of creating a multifunctional viscoelastic compressive applicator taken along lines 2-2 of FIG. 1 according to an embodiment;

FIG. 3 is a cross-sectional side view of a mold fora method of creating a multifunctional viscoelastic compressive applicator taken along lines 2-2 of FIG. 1 filled with a predetermined amount of viscoelastic material and the mold cover positioned to close the mold and create a fixed mold cavity volume inside the mold according to an embodiment;

FIG. 4 is a cross-sectional side view of a closed mold for a method of creating a multifunctional viscoelastic compressive applicator taken along lines 2-2 of FIG. 1 that had been filled with a predetermined amount of viscoelastic material where the predetermined amount of viscoelastic material has been allowed to expand and cure thereby filling the mold and creating a finished product according to an embodiment;

FIG. 5 is a perspective view of a finished product according to an embodiment of a method of creating a multifunctional viscoelastic compressive applicator;

FIG. 6 is a top view of a mold for a method of creating a multifunctional viscoelastic compressive applicator according to an embodiment;

FIG. 7 is a cross-sectional side view of a mold for a method of creating a multifunctional viscoelastic compressive applicator taken along lines 7-7 of FIG. 6 according to an embodiment;

FIG. 8 is a cross-sectional side view of a mold for a method of creating a multifunctional viscoelastic compressive applicator taken along lines 7-7 of FIG. 6 filled with a predetermined amount of viscoelastic material, a first attachment mechanism placed onto a first at least one interior surface of the mold and the mold cover positioned to close the mold and create a fixed mold cavity volume inside the mold according to an embodiment;

FIG. 9 is a cross-sectional side view of a closed mold for a method of creating a multifunctional viscoelastic compressive applicator taken along lines 7-7 of FIG. 6 that had been filled with a predetermined amount of viscoelastic material, and a first attachment mechanism placed onto a first at least one interior surface of the mold where the predetermined amount of viscoelastic material has been allowed to expand and cure thereby filling the mold, affixing the first attachment mechanism and creating a finished product according to an embodiment;

FIG. 10 is a perspective view of a finished product according to an embodiment of a method of creating a multifunctional viscoelastic compressive applicator;

FIG. 11 is a top view of a mold for a method of creating a multifunctional viscoelastic compressive applicator according to an embodiment;

FIG. 12 is a cross-sectional side view of a mold for a method of creating a multifunctional viscoelastic compressive applicator taken along lines 12-12 of FIG. 11 according to an embodiment;

FIG. 13 is a cross-sectional side view of a mold for a method of creating a multifunctional viscoelastic compressive applicator taken along lines 12-12 of FIG. 11 filled with a predetermined amount of viscoelastic material, a first attachment mechanism placed onto a first at least one interior surface of the mold, a second attachment mechanism placed onto a second at least one interior surface of the mold, and the mold cover positioned to close the mold and create a fixed mold cavity volume inside the mold according to an embodiment;

FIG. 14 is a cross-sectional side view of a closed mold for a method of creating a multifunctional viscoelastic compressive applicator taken along lines 12-12 of FIG. 11 that had been filled with a predetermined amount of viscoelastic material, a first attachment mechanism placed onto a first at least one interior surface of the mold, and a second attachment mechanism placed onto a second at least one interior surface of the mold where the predetermined amount of viscoelastic material has been allowed to expand and cure thereby filling the mold, affixing the first attachment mechanism and second attachment mechanism, and creating a finished product according to an embodiment; and

FIG. 15 is a perspective view of a finished product according to an embodiment of a method of creating a multifunctional viscoelastic compressive applicator.

Various features, aspects, and advantages of the embodiments will become more apparent from the following detailed description, along with the accompanying figures in which like numerals represent like components throughout the figures and text. The various described features are not necessarily drawn to scale, but are drawn to emphasize specific features relevant to some embodiments.

### DETAILED DESCRIPTION

Reference will now be made in detail to various embodiments. Each example is provided by way of explanation, and is not meant as a limitation and does not constitute a definition of all possible embodiments.

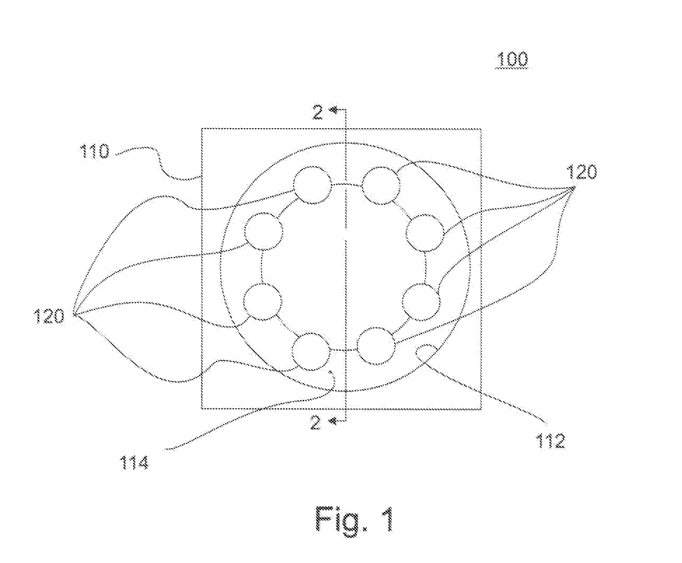

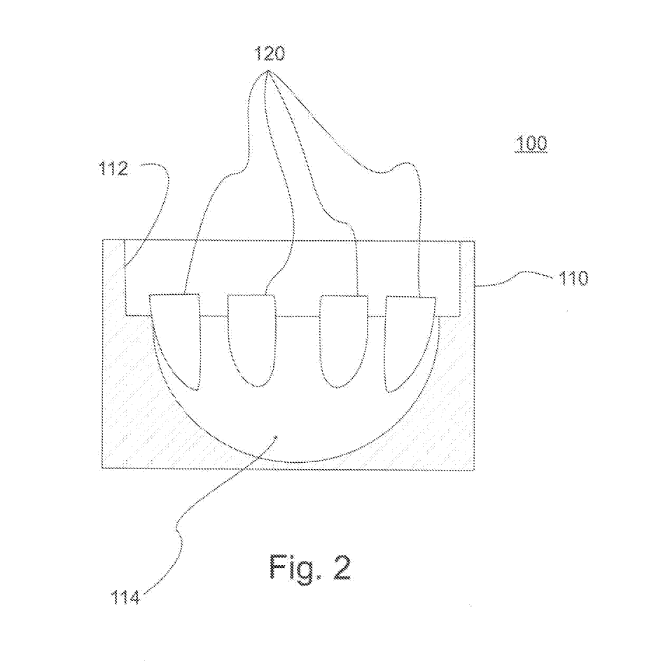

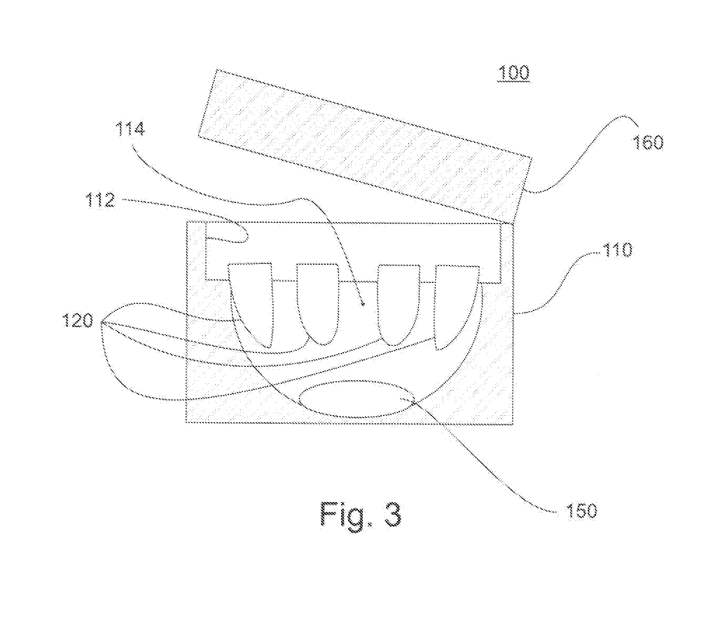

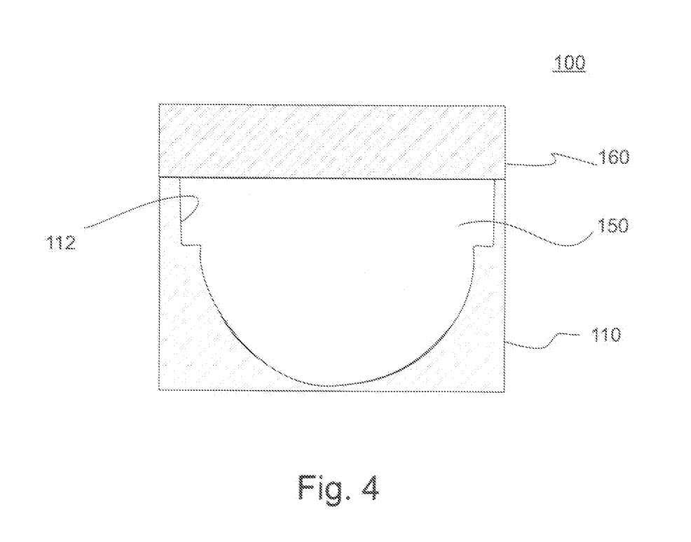

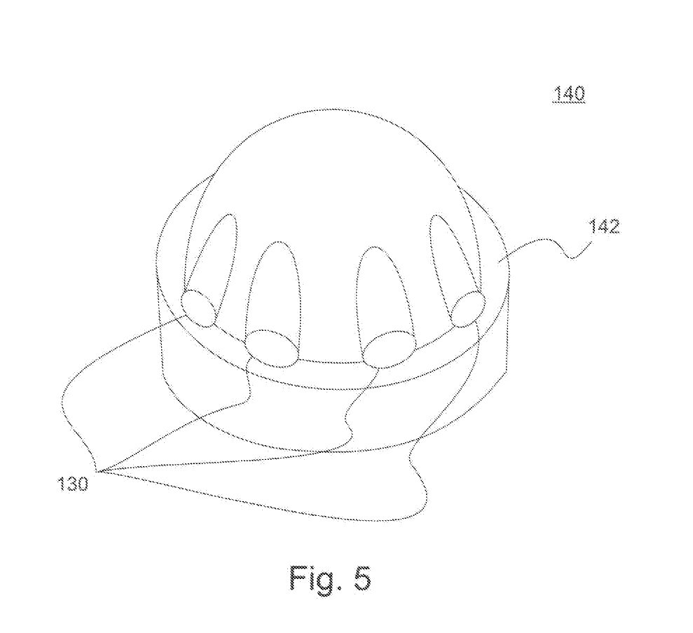

For purposes of illustrating features of the embodiments, a simple example will now be introduced and referenced throughout the disclosure. Those skilled in the art will recognize that this example is illustrative and not limiting and is provided purely for explanatory purposes. In the illustrative example and as seen in FIGS. 1, 2, 3, 4 and 5.

Turning now to FIGS. 1, 2, 3, 4 and 5 which show an embodiment of a method of creating a multifunctional viscoelastic compressive applicator (100) comprising: obtaining a mold (110), the mold (110) having a plurality of appendages (120) protruding from the interior surfaces (112) of the mold (110) towards the interior of the mold cavity (114) and the plurality of appendages (120) capable of creating a plurality of slices, indentations, cavities, hollows, voids or augmentations (130) in a finished product (140); filling the mold (110) with a predetermined amount of viscoelastic material (150); closing the mold cover (160) to create a fixed mold cavity (114) volume inside the mold (110); and allowing the predetermined amount of viscoelastic material (150) to expand and cure inside the fixed mold cavity (114) volume of the mold (110) whereby the expanding and curing of the predetermined amount of viscoelastic material (150) inside the mold (110) fills the mold (110) and creates a compressive force that acts on the viscoelastic material (150) to create the finished product (140).

In another embodiment of the method of creating the multifunctional viscoelastic compressive applicator (100) further comprises wherein the finished product (140) has a density in the range of between two (2) pounds per cubic foot and twenty-five (25) pounds per cubic foot.

In yet another embodiment of the method of creating the multifunctional viscoelastic compressive applicator (100) further comprises wherein the finished product (140) has a density in the range of between two (2) pounds per cubic foot and four (4) pounds per cubic foot.

In still another embodiment of the method of creating the multifunctional viscoelastic compressive applicator (100) further comprises wherein the plurality of appendages (120) creating the plurality of slices, indentations, cavities, hollows, voids or augmentations (130) are configured so that the plurality of slices, indentations, cavities, hollows, voids or augmentations (130) are wider at an outer surface of the finished product (140) and taper down narrower as the slices, indentations, cavities, hollows, voids or augmentations (130) go deeper into the finished product (140).

In another embodiment of the method of creating the multifunctional viscoelastic compressive applicator (100) further comprises wherein the plurality of appendages (120) creating the plurality of slices, indentations, cavities, hollows, voids or augmentations (130) are configured so that the plurality of slices, indentations, cavities, hollows, voids or augmentations (130) are at an angle other than perpendicular to an outer surface (142) of the finished product (140).

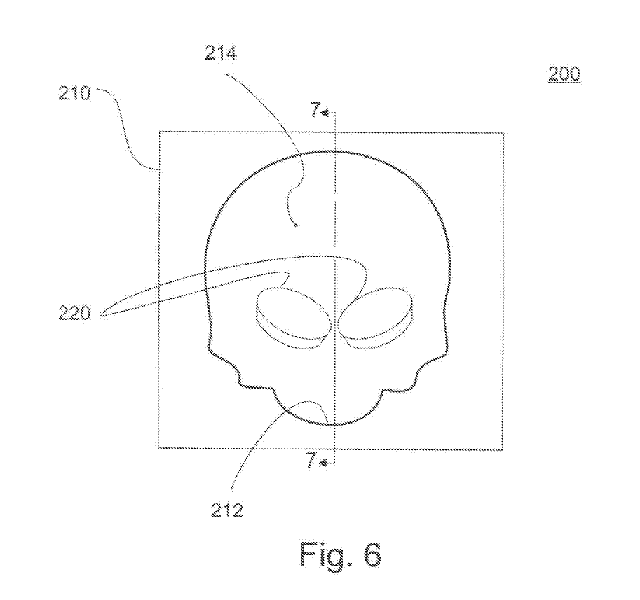

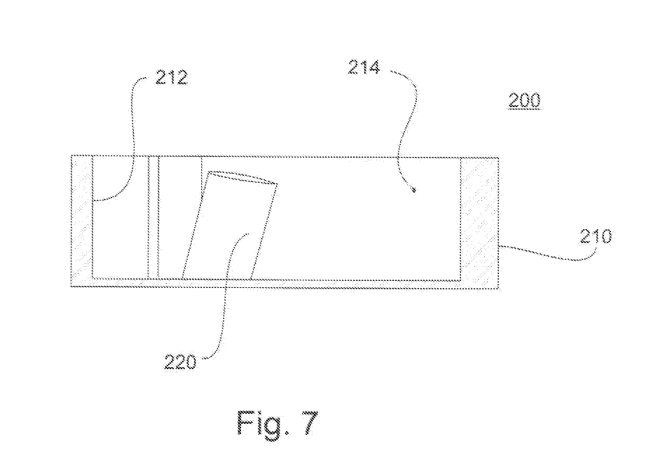

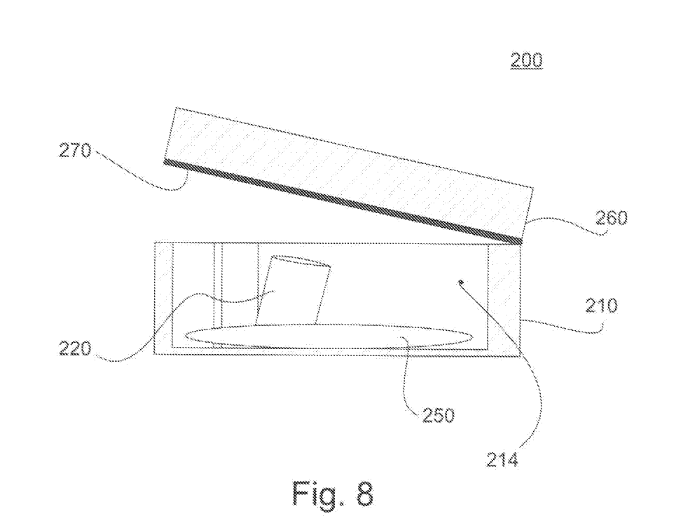

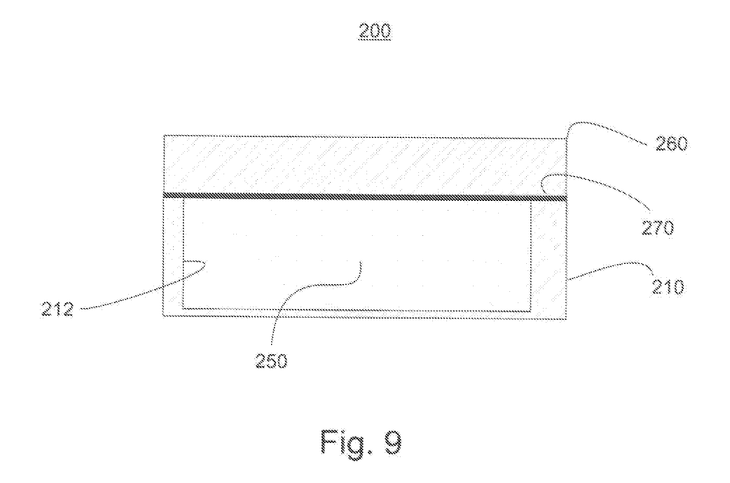

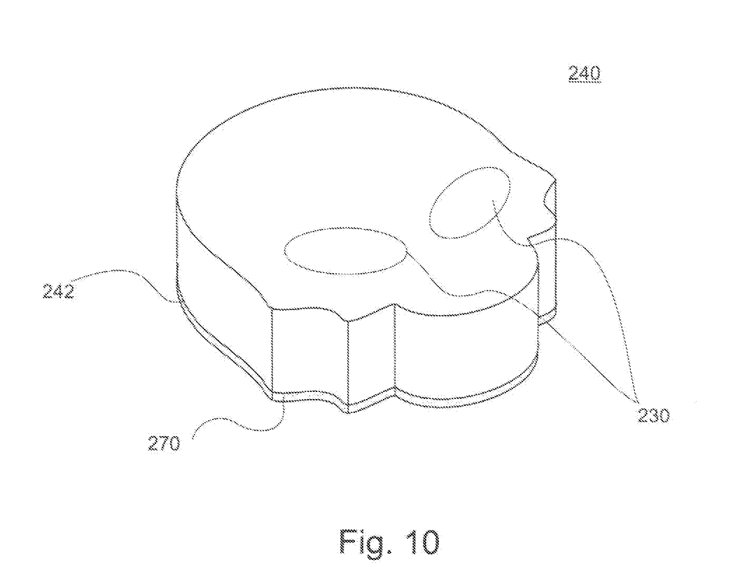

Turning now to FIGS. 6, 7, 8, 9 and 10 which show an embodiment of a method of creating a multifunctional viscoelastic compressive applicator (200) comprising: obtaining a mold (210), the mold (210) having a plurality of appendages (220) protruding from the interior surfaces (212) of the mold (210) towards the interior of the mold cavity (214) and the plurality of appendages (220) capable of creating a plurality of slices, indentations, cavities, hollows, voids or augmentations (230) in a finished product (240); placing a first attachment mechanism (270) onto a first at least one interior surface (212) of the mold (210); filling the mold (210) with a predetermined amount of viscoelastic material (250); closing the mold cover (260) to create a fixed mold cavity (214) volume inside the mold (210); and allowing the predetermined amount of viscoelastic material (250) to expand and, cure inside the fixed mold cavity (214) volume of the mold (210) whereby the expanding and curing of the predetermined amount of viscoelastic material (250) inside the mold (210) fills the mold (210) and creates a compressive force that acts on the viscoelastic material (250) to affix the first attachment mechanism (270) to the predetermined amount of viscoelastic material (250) to create the finished product (240).

In another embodiment of the method of creating the multifunctional viscoelastic compressive applicator (200) further comprises wherein the finished product (240) has a density in the range of between two (2) pounds per cubic foot and twenty-five (25) pounds per cubic foot.

In yet another embodiment of the method of creating the multifunctional viscoelastic compressive applicator (200) further comprises wherein the finished product (240) has a density in the range of between two (2) pounds per cubic foot and four (4) pounds per cubic foot.

In still another embodiment of the method of creating the multifunctional viscoelastic compressive applicator (200) further comprises wherein the plurality of appendages (220) creating the plurality of slices, indentations, cavities, hollows, voids or augmentations (230) are configured so that the plurality of slices, indentations, cavities, hollows, voids or augmentations (230) are wider at an outer surface of the finished product (242) and taper down narrower as the slices, indentations, cavities, hollows, voids or augmentations (230) go deeper into the finished product (240).

In another embodiment of the method of creating the multifunctional viscoelastic compressive applicator (200) further comprises wherein the plurality of appendages (220) creating the plurality of slices, indentations, cavities, hollows, voids or augmentations (230) are, configured so that the plurality of slices, indentations, cavities, hollows, voids or augmentations (230) are at an angle other than perpendicular to an outer surface (242) of finished product (240).

In yet still another embodiment of the method of creating the multifunctional viscoelastic compressive applicator (200) further comprises wherein the first attachment mechanism (270) placed onto the first at least one interior surface (212) of the mold is at least one of a hook and loop fastener, a male and female fastener, or a surface tension fastener.

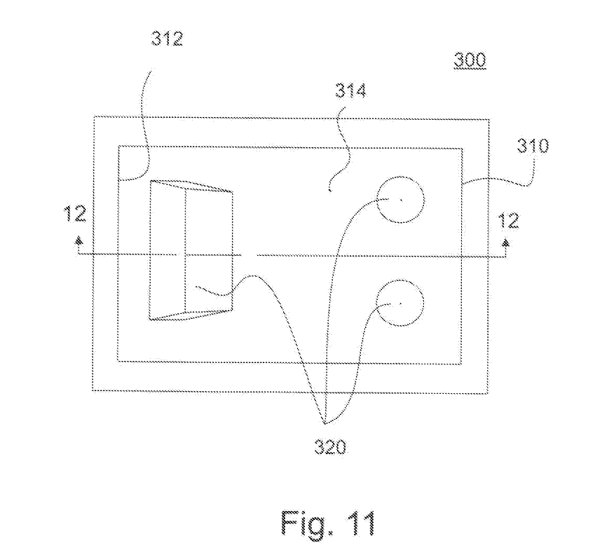

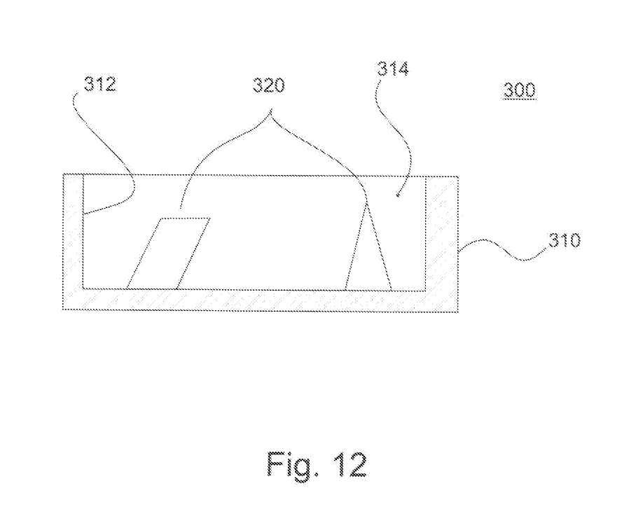

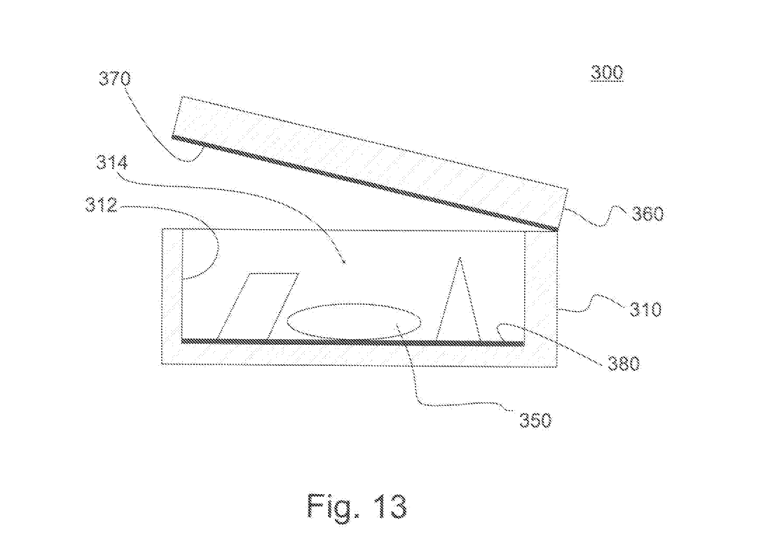

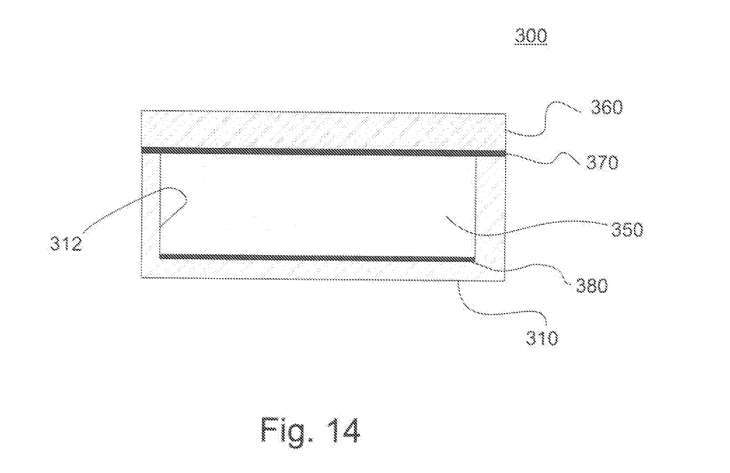

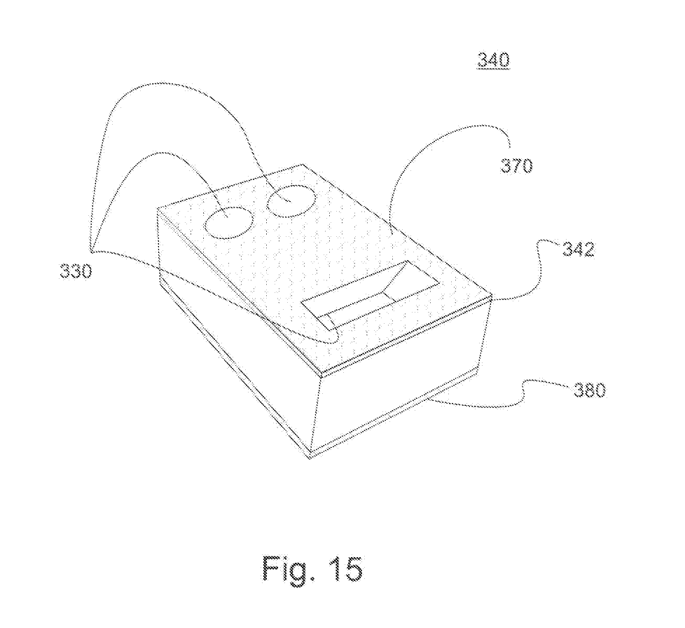

Turning now to FIGS. 11, 12, 13, 14 and 15 which show an embodiment of a method of creating a multifunctional viscoelastic compressive applicator (300) comprising: obtaining a mold (310), the mold (310) having a plurality of appendages (320) protruding from the interior surfaces (312) of the mold (310) towards the interior of the mold cavity (314) and the plurality of appendages (320) capable of creating a plurality of slices, indentations, cavities, hollows, voids or augmentations (330) in a finished product (340); placing a first attachment mechanism (370) onto a first at least one interior surface (312) of the mold (310); placing a second attachment mechanism (380) onto a second at least one interior surface (312) of the mold (310); filling the mold (310) with a predetermined amount of viscoelastic material (350); closing the mold cover (360) to create a fixed mold cavity (314) volume inside the mold (310); and allowing the predetermined amount of viscoelastic material (350) to expand and cure inside the fixed mold cavity (314) volume of the mold (310) whereby the expanding and curing of the predetermined amount of viscoelastic material (350) inside the mold (310) fills the mold (310) and creates a compressive force that acts on the viscoelastic material (350) to affix the first attachment mechanism (370) and the second attachment mechanism (380) to the predetermined amount of viscoelastic material (350) to create the finished product (340).

In another embodiment of the method of creating the multifunctional viscoelastic compressive applicator (300) further comprises wherein the finished product (340) has a density in the range of between two (2) pounds per cubic foot and twenty-five (25) pounds per cubic foot.

In yet another embodiment of the method of creating the multifunctional viscoelastic compressive applicator (300) further comprises wherein the finished product (340) has a density in the range of between two (2) pounds per cubic foot and four (4) pounds per cubic foot.

In still another embodiment of the method of creating the multifunctional viscoelastic compressive applicator (300) further comprises wherein the plurality of appendages (320) creating the plurality of slices, indentations, cavities, hollows, voids or augmentations (330) are configured so that the plurality of slices, indentations, cavities, hollows, voids or augmentations (330) are wider at an outer surface (342) of the finished product (340) and taper down narrower as the slices, indentations, cavities, hollows, voids or augmentations (330) go deeper into the finished product (340).

In still yet another embodiment of the method of creating the multifunctional viscoelastic compressive applicator (300) further comprises wherein the plurality of appendages (320) creating the plurality of slices, indentations, cavities, hollows, voids or augmentations (330) are configured so that the plurality of slices, indentations, cavities, hollows, voids or augmentations (330) are at an angle other than perpendicular to an outer surface (342) of the finished product (340).

In another embodiment of the method of creating the multifunctional viscoelastic compressive applicator (300) further comprises wherein the first attachment mechanism (370) placed onto the first at least one interior surface (312) of the mold (310) is at least one of a hook and loop fastener, a male and female fastener, or a surface tension fastener.

In yet still another embodiment of the method of creating the multifunctional viscoelastic compressive applicator (300) further comprises wherein the second attachment mechanism (380) placed onto the second at least one interior surface (312) of the mold (310) is at least one of a hook and loop fastener, a male and female fastener, or a surface tension fastener.

The components of the apparatus illustrated are not limited to the specific embodiments described herein, but rather, features illustrated or described as part of one embodiment can be used on or in conjunction with other embodiments to yield yet a further embodiment. It is intended that the apparatus include such modifications and variations. Further, steps described in the method may be utilized independently and separately from other steps described herein.

While the apparatus and method have been described with reference to specific embodiments, it will be understood by those skilled in the art that various changes may be made and equivalents may be substituted for elements thereof without departing from the scope contemplated. In addition, many modifications may be made to adapt a particular situation or material to the teachings found herein without departing from the essential scope thereof.

In this specification and the claims that follow, reference will be made to a number of terms that have the following meanings. The singular forms “a,” “an” and “the” include plural referents unless the context clearly dictates otherwise. Furthermore, references to “one embodiment”, “some embodiments”, “an embodiment” and the like are not intended to be interpreted as excluding the existence of additional embodiments that also incorporate the recited features. Approximating language, as used herein throughout the specification and claims, may be applied to modify any quantitative representation that could permissibly vary without resulting in a change in the basic function to which it is related. Accordingly, a value modified by a term such as “about” is not to be limited to the precise value specified. In some instances, the approximating language may correspond to the precision of an instrument for measuring the value. Terms such as “first,” “second,” “upper,” “lower” etc. are used to identify one element from another, and unless otherwise specified are not meant to refer to a particular order or number of elements.

As used herein, the terms “may” and “may be” indicate a possibility of an occurrence within a set of circumstances; a possession of a specified property, characteristic or function; and/or qualify another verb by expressing, one or more of an ability, capability, or possibility associated with the qualified verb. Accordingly, usage of “may” and “may be” indicates that a modified term is apparently appropriate, capable, or suitable for an indicated capacity, function, or usage, while taking into account that in some circumstances the modified term may sometimes not be appropriate, capable, or suitable. For example, in some circumstances an event or capacity can be expected, while in other circumstances the event or capacity cannot occur—this distinction is captured by the terms “may” and “may be.”

As used in the claims, the word “comprises” and its grammatical variants logically also subtend and include phrases of varying and differing extent such as for example, but not limited thereto, “consisting essentially of” and “consisting of.” Where necessary, ranges have been supplied, and those ranges are inclusive of all sub-ranges there between. It is to be expected that variations in these ranges will suggest themselves to a practitioner having ordinary skill in the art and, where not already dedicated to the public, the appended claims should cover those variations.

Advances in science and technology may make equivalents and substitutions possible that are not now contemplated by reason of the imprecision of language; these variations should be covered by the appended claims. This written description uses examples to disclose the method, machine and computer-readable medium, including the best mode, and also to enable any person of ordinary skill in the art to practice these, including making and using any devices or systems and performing any incorporated methods. The patentable scope thereof is defined by the claims, and may include other examples that occur to those of ordinary skill in the art. Such other examples are intended to be within the scope of the claims if they have structural elements that do not differ from the literal language of the claims, or if they include equivalent structural elements with insubstantial differences from the literal language of the claims.

What is claimed is:

1. A method of creating a multifunctional viscoelastic compressive applicator comprising:
obtaining a mold, the mold having a plurality of appendages protruding from the interior surfaces of the mold towards the interior of the mold cavity and the plurality of appendages capable of creating a plurality of slices, indentations, cavities, hollows, voids or augmentations in a finished product;
filling the mold with a predetermined amount of viscoelastic material;
closing the mold cover to create a fixed mold cavity volume inside the mold; and
allowing the predetermined amount of viscoelastic material to expand and cure inside the fixed mold cavity volume of the mold whereby the expanding and curing of the predetermined amount of viscoelastic material inside the mold fills the mold and creates a compressive force that acts on the viscoelastic material to create the finished product.

2. The method of creating the multifunctional viscoelastic compressive applicator of claim 1 further comprising wherein the finished product has a density in the range of between two (2) pounds per cubic foot and twenty-five (25) pounds per cubic foot.

3. The method of creating the multifunctional viscoelastic compressive applicator of claim 2 further comprising wherein the finished product has a density in the range of between two (2) pounds per cubic foot and four (4) pounds per cubic foot.

4. The method of creating the multifunctional viscoelastic compressive applicator of claim 1 further comprising wherein the plurality of appendages creating the plurality of slices, indentations, cavities, hollows, voids or augmentations are configured so that the plurality of slices, indentations, cavities, hollows, voids or augmentations are wider at an outer surface of the finished product and taper down narrower as the slices, indentations, cavities, hollows, voids or augmentations go deeper into the finished product.

5. The method of creating the multifunctional viscoelastic compressive applicator of claim 1 further comprising wherein the plurality of appendages creating the plurality of slices, indentations, cavities, hollows, voids or augmentations are configured so that the plurality of slices, indentations, cavities, hollows, voids or augmentations are at an angle other than perpendicular to an outer surface of the finished product.

6. A method of creating a multifunctional viscoelastic compressive applicator comprising:
obtaining a mold, the mold having a plurality of appendages protruding from the interior surfaces of the mold towards the interior of the mold cavity and the plurality of appendages capable of creating a plurality of slices, indentations, cavities, hollows, voids or augmentations in a finished product;
placing a first attachment mechanism onto a first at least one interior surface of the mold;
filling the mold with a predetermined amount of viscoelastic material;
closing the mold cover to create a fixed mold cavity volume inside the mold; and
allowing the predetermined amount of viscoelastic material to expand and cure inside the fixed mold cavity volume of the mold whereby the expanding and curing of the predetermined amount of viscoelastic material inside the mold fills the mold and creates a compressive force that acts on the viscoelastic material to affix the first attachment mechanism to the predetermined amount of viscoelastic material to create the finished product.

7. The method of creating the multifunctional viscoelastic compressive applicator of claim 6 further comprising wherein the finished product has a density in the range of between two (2) pounds per cubic foot and twenty-five (25) pounds per cubic foot.

8. The method of creating the multifunctional viscoelastic compressive applicator of claim 7 further comprising wherein the finished product has a density in the range of between two (2) pounds per cubic foot and four (4) pounds per cubic foot.

9. The method of creating the multifunctional viscoelastic compressive applicator of claim 6 further comprising wherein the plurality of appendages creating the plurality of slices, indentations, cavities, hollows, voids or augmentations are configured so that the plurality of slices, indentations, cavities, hollows, voids or augmentations are wider at an outer surface of the finished product and taper down narrower as the slices, indentations, cavities, hollows, voids or augmentations go deeper into the finished product.

10. The method of creating the multifunctional viscoelastic compressive applicator of claim 6 further comprising wherein the plurality of appendages creating the plurality of slices, indentations, cavities, hollows, voids or augmentations are configured so that the plurality of slices, indentations, cavities, hollows, voids or augmentations are at an angle other than perpendicular to an outer surface of the finished product.

11. The method of creating the multifunctional viscoelastic compressive applicator of claim 6 further comprising wherein the first attachment mechanism placed onto the first at least one interior surface of the mold is at least one of a hook and loop fastener, a male and female fastener, or a surface tension fastener.

12. A method of creating a multifunctional viscoelastic compressive applicator comprising:
obtaining a mold, the mold having a plurality of appendages protruding from the interior surfaces of the mold towards the interior of the mold cavity and the plurality of appendages capable of creating a plurality of slices, indentations, cavities, hollows, voids or augmentations in a finished product;
placing a first attachment mechanism onto a first at least one interior surface of the mold;
placing a second attachment mechanism onto a second at least one interior surface of the mold;
filling the mold with a predetermined amount of viscoelastic material;
closing the mold cover to create a fixed mold cavity volume inside the mold; and
allowing the predetermined amount of viscoelastic material to expand and cure inside the fixed mold cavity volume of the mold whereby the expanding and curing of the predetermined amount of viscoelastic material inside the mold fills the mold and creates a compressive force that acts on the viscoelastic material to affix the first attachment mechanism and the second attachment mechanism to the predetermined amount of viscoelastic material to create the finished product.

13. The method of creating the multifunctional viscoelastic compressive applicator of claim 12 further comprising wherein the finished product has a density in the range of between two (2) pounds per cubic foot and twenty-five (25) pounds per cubic foot.

14. The method of creating the multifunctional viscoelastic compressive applicator of claim 13 further comprising wherein the finished product has a density in the range of between two (2) pounds per cubic foot and four (4) pounds per cubic foot.

15. The method of creating the multifunctional viscoelastic compressive applicator of claim 12 further comprising wherein the plurality of appendages creating the plurality of slices, indentations, cavities, hollows, voids or augmentations are configured so that the plurality of slices, indentations, cavities, hollows, voids or augmentations are wider at an outer surface of the finished product and taper down narrower as the slices, indentations, cavities, hollows, voids or augmentations go deeper into the finished product.

16. The method of creating the multifunctional viscoelastic compressive applicator of claim 12 further comprising wherein the plurality of appendages creating the plurality of slices, indentations, cavities, hollows, voids or augmentations are configured so that the plurality of slices, indentations, cavities, hollows, voids or augmentations are at an angle other than perpendicular to an outer surface of the finished product.

17. The method of creating the multifunctional viscoelastic compressive applicator of claim 12 further comprising wherein the first attachment mechanism placed onto the first at least one interior surface of the mold is at least one of a hook and loop fastener, a male and female fastener, or a surface tension fastener.

18. The method of creating the multifunctional viscoelastic compressive applicator of claim 12 further comprising wherein the second attachment mechanism placed onto the second at least one interior surface of the mold is at least one of a hook and loop fastener, a male and female fastener, or a surface tension fastener.
